(19) United States
(12) Patent Application Publication
(10) Pub. No.: US 2015/0002995 A1
(43) Pub. Date: Jan. 1, 2015

(54) KEYBOARD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WEI-KUANG LIANG, New Taipei (TW); WENG-TIANG TANG, New Taipei (TW); CAN JIA, Shenzhen (CN); PEI-HUA ZHANG, Shenzhen (CN)

(21) Appl. No.: 14/313,746

(22) Filed: Jun. 24, 2014

(30) Foreign Application Priority Data
Jun. 28, 2013 (CN) 2013102660618

(51) Int. Cl. G06F 3/02

(52) U.S. Cl. CPC G06F 3/0202
USPC 361/679.08

(57) ABSTRACT

A keyboard includes a frame, a keyboard module, and a shielding member. The frame defines an opening and comprises a lateral flange. The keyboard module is located in the opening and includes a plurality of keys. A gap is defined between the keyboard and the lateral flange. The shielding member covers and shields the gap under the keyboard module.

### CROSS-REFERENCE TO RELATED APPLICATIONS

This application claims priority to Chinese Patent Application No. 201310266061.8 filed on Jun. 28, 2013 in the China Intellectual Property Office, the contents of which are incorporated by reference herein.

### FIELD

The subject matter herein generally relates to a keyboard of an electronic device

### BACKGROUND

An electronic device can include an input device such as a keyboard, a mouse, or a trackball. The keyboard includes a base and a plurality of keys. The keys can be pressed relative to the base. A space is left between the key and the base.

### BRIEF DESCRIPTION OF THE DRAWINGS

Implementations of the present technology will be described, by way of example only, with reference to the attached figures.

FIG. 1 is an exploded, isometric view of a keyboard according to one embodiment.

FIG. 2 is an assembled view of the keyboard of FIG. 1.

FIG. 3 is a cross sectional view of the keyboard along line III-III of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to mean essentially conforming to the particular dimension, shape, or other feature that is modified, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure describes a keyboard with a keyboard module.

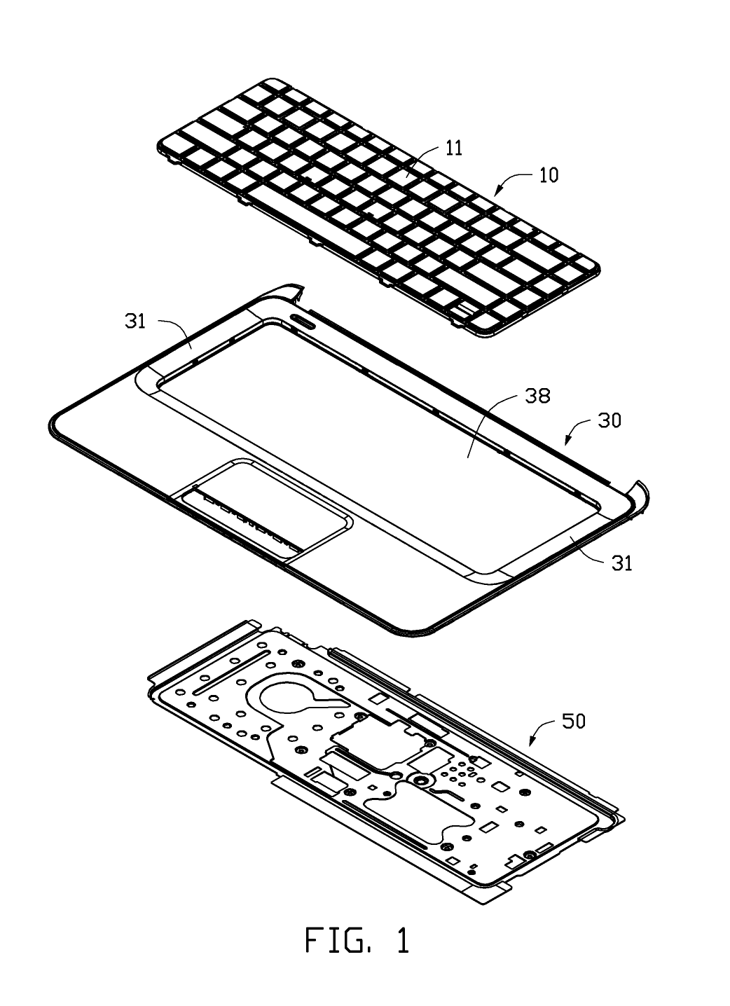

FIG. 1 illustrates an example embodiment of a keyboard. The keyboard includes a keyboard module 10, a frame 30, and a bracket 50. The keyboard module 10 includes a plurality of keys 11. The keyboard module 10 is substantially rectangular in shape. The frame 30 defines an opening 38 for receiving the keyboard module 10. The opening 38 is substantially rectangular. The frame 30 includes at least two lateral flanges 31 on opposite sides of the opening 38. The bracket 50 can be mounted under the frame 30 and the keyboard module 10. The bracket 50 can be a metal sheet and can be a bottom cover of an electronic device.

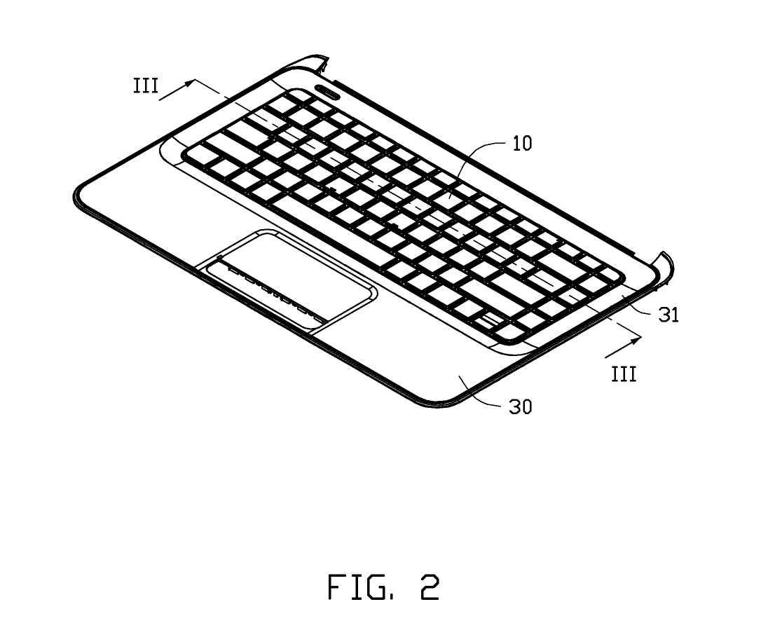

FIG. 2 illustrates an example embodiment of an assembled view of the keyboard. The keyboard module 10 is located in the opening of the frame 30. The bracket is located under the frame 30 and the keyboard module 10.

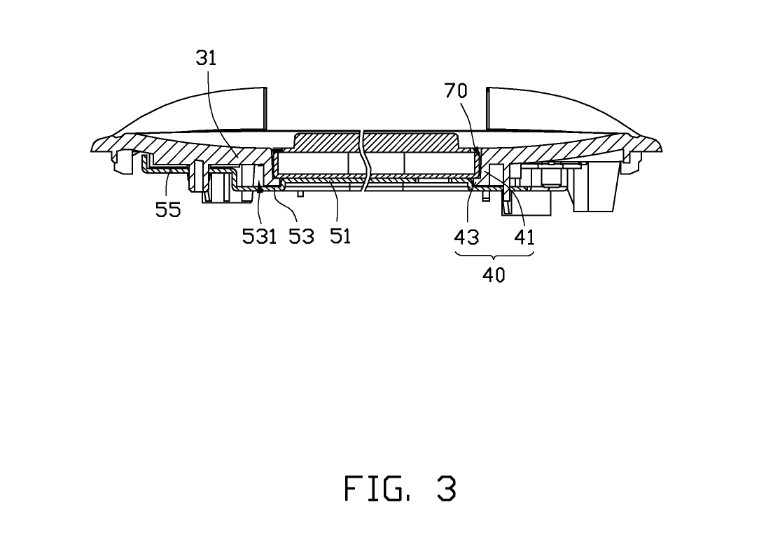

FIG. 3 illustrates a cross sectional view of the keyboard along lines III-III of FIG. 2. A shielding member 40 extends from each lateral flange 31 and extends to a bottom portion of the keyboard module 31. The shielding member 40 includes an extension portion 41 and a shielding portion 43. The extension portion 41 is substantially perpendicular to the shielding portion 43. A cross section of the shielding member 40 is substantially L-shaped. A gap 70 is defined between each lateral flange 31 and the keyboard module 10. The shielding member 40 can shield the gap 70 from a viewpoint above the keyboard module 10. A length of the shielding portion 43 is greater than a width of the gap 70. The bracket 50 is mounted to the frame 30 to support the keyboard module 10. The bracket 50 includes an installing board 55, a turning board 53, and a supporting board 51. The turning board 53 defines a recess 531 to receive the shielding portion 43. A cross section of the recess 531 is substantially U-shaped. A thickness of the shielding member 40 can be greater than a thickness of the bracket 50. The supporting board 51 is adjacent to the bottom portion of the keyboard module 10.

In assembly, when the keyboard is in use, the shielding member can shield the gap from a viewpoint above a top of the keyboard module.

In another embodiment, a shielding member can be J-shaped in a cross sectional view. The shielding member can be detachable from the frame 30.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including the details of shape, size, and arrangement of the parts within the principles of the present disclosure up to, and including, the full extent established by the broad general meaning of the terms used in the claims.

What is claimed is:

1. A keyboard comprising:
a frame defining an opening and comprising a lateral flange;
a keyboard module located in the opening and comprising a plurality of keys, a gap defined between the keyboard and the lateral flange; and
a shielding member shielding the gap under the keyboard module.

2. The keyboard of claim 1, wherein a cross section of the shielding member is substantially L-shaped.

3. The keyboard of claim 2, wherein the shielding member comprises an extension portion and a shielding portion, and the extension portion is substantially perpendicular to the shielding portion.

4. The keyboard of claim 3, wherein a length of the extension portion is greater than a width of the gap.

5. The keyboard of claim 1, further comprising a bracket, wherein the bracket is mounted to the frame to support the keyboard module.

6. The keyboard of claim 5, wherein the bracket defines a recess to receive the shielding member.

7. The keyboard of claim 6, wherein a cross section of the recess is substantially U-shaped.

8. The keyboard of claim 7, wherein a thickness of the shielding member is greater than a thickness of the bracket.

9. The keyboard of claim 7, wherein the bracket is located under the keyboard module and the frame.

10. A keyboard comprising:
a frame defining an opening and comprising a lateral flange; and
a keyboard module located in the opening and comprising a plurality of keys, a gap defined between the keyboard and the lateral flange;
wherein the frame further comprises a shielding member, and the shielding member extends to shielding the gap.

11. The keyboard of claim 10, wherein a cross section of the shielding member is substantially L-shaped.

12. The keyboard of claim 11, wherein the shielding member comprises an extension portion and a shielding portion, and the extension portion is substantially perpendicular to the shielding portion.

13. The keyboard of claim 12, wherein a length of the extension portion is greater than a width of the gap.

14. The keyboard of claim 10, further comprising a bracket, wherein the bracket is mounted to the frame to support the keyboard module.

15. The keyboard of claim 14, wherein the bracket defines a recess to receive the shielding member.

16. The keyboard of claim 15, wherein a cross section of the recess is substantially U-shaped.

17. The keyboard of claim 16, wherein a thickness of the shielding member is greater than a thickness of the bracket.

18. The keyboard of claim 17, wherein the bracket is located under the keyboard module and the frame.

19. A keyboard comprising:
a keyboard module comprising a plurality of keys;
a frame defining an opening configured to receive the keyboard module and comprising a lateral flange, wherein a gap is formed between the keyboard received in the opening and the lateral flange; and
a shielding member configured to fill the gap under the keyboard module.
